(19) United States
(12) Patent Application Publication
(10) Pub. No.: US 2025/0131501 A1
(43) Pub. Date: Apr. 24, 2025

(54) SYSTEM AND METHOD FOR ADVANCED ANALYSIS OF EARNINGS CALL TRANSCRIPTS BASED ON ANALYSTS' BEHAVIOR AND QUESTION SENTIMENT WITH GENERATIVE QUESTION CAPABILITY

(71) Applicant: Dell Products L.P., Round Rock, TX (US)

(72) Inventors: Priyanka Pathak, Hyderabad (IN); Adya Jha, Bengaluru (IN); Saurabh Jha, Austin, TX (US)

(21) Appl. No.: 18/490,695

(22) Filed: Oct. 19, 2023

(51) Int. Cl. G06F 16/332

(52) U.S. Cl. CPC G06Q 40/06; G06Q 10/0637

(57) ABSTRACT

One example method includes preparing a document draft, performing an automated sentiment analysis on the document draft, performing an automated topic generation process based on the document draft and based on an outcome of the automated sentiment analysis, performing an automated question generation process based on the document draft and based on an outcome of the automated topic generation process, and the automated question generation process is performed for each of one or more consumers of the document draft, after consumption of the document draft by the consumers, performing another automated sentiment analysis process on the document draft using sentiments associated with input, concerning the document draft, provided by the consumers, and automatically updating a list of topics, generated by the automated topic generation process, based on contents of a transcript that includes the input provided by the consumers.

### FIELD OF THE INVENTION

Embodiments of the present invention generally relate to behavioral and textual analysis. More particularly, at least some embodiments of the invention relate to systems, hardware, software, computer-readable media, and methods, for discovering human behavior patterns based on textual analysis of a document.

### BACKGROUND

When preparing to present information to an audience, it can be difficult for the presenter to anticipate questions and issues that may be raised by audience members. Moreover, the sentiments of audience members may play an important role in the responses of the presenter, but it is difficult to anticipate what the mood and sentiments of the audience members may be at various times during the presentation.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a method according to one embodiment.

FIG. 2 discloses aspects of an example earnings call agenda.

FIG. 3 discloses example ratios of type of questions asked by analysts.

FIG. 4 discloses analyst questions sentiment comparison for an example set of companies.

FIG. 5 discloses an example behavioral cluster of analysts based on ratings and sentiment score.

FIG. 6 discloses an example knowledge graph from the earnings call transcripts, according to an embodiment.

FIG. 7 discloses conversion of a graph base to a knowledge graph, according to an embodiment.

FIG. 8 discloses an example LM (language model) architecture, according to an embodiment.

FIG. 9 discloses examples of LM task relations, according to an embodiment.

FIG. 10 discloses an example architecture and method for prompt learning for question generation, according to an embodiment.

FIG. 11 discloses an overview of aspects of an example architecture and method, according to one embodiment.

FIG. 12 discloses an example earnings report.

FIG. 13 discloses an example of key extraction from an earnings report, according to an embodiment.

FIG. 14 discloses examples of generated questions based on analyst behavior, according to an embodiment.

FIG. 15 discloses an example computing entity operable to perform any of the disclosed methods, processes, and operations.

### DETAILED DESCRIPTION OF SOME EXAMPLE EMBODIMENTS

Embodiments of the present invention generally relate to behavioral and textual analysis. More particularly, at least some embodiments of the invention relate to systems, hardware, software, computer-readable media, and methods, for discovering human behavior patterns based on textual analysis of a document. While this disclosure refers to the example of analysis of earnings call documents, that is solely for the purposes of illustration and should not be considered as limiting the scope of the invention in any way.

One example embodiment of the invention comprises an approach for automating sentiment analysis within earnings call transcripts for a competitive set of companies over time using AI/ML algorithms to inform IR decision-making and investor communication.

In more detail, an example embodiment comprises an analysis technique embedded in the process of generation of earnings call transcripts. This technique is based on modeling analyst behavior and question asking patterns, and utilizes various machine learning techniques to identify these patterns. Specifically, a technique according to one embodiment determines the sentiment of questions asked during the calls by applying a mixed approach that combines clustering algorithms, topic modeling, and deep learning models.

The clustering algorithms are used to group analysts based on their behavior during earnings calls, which can be used to develop a behavior model for each group of analysts. This model can then be used to generate questions that are tailored to their preferences, allowing companies to better prepare for earnings calls and deliver more targeted responses. The topic modeling technique is used to identify the topics and themes that are commonly discussed during earnings calls. This helps companies to understand the topics and themes that are of interest to analysts, and to identify potential areas of concern that may require further explanation or clarification during earnings calls.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the behavior of a human, such as an analyst in one embodiment, may be predicted based on documents that implicitly and/or explicitly contain information concerning past behavior of the human. An embodiment may help to improve communications between parties based on analysis of past behavior of one of the parties. Various other advantages of one or more example embodiments will be apparent from this disclosure.

### a. Introduction for an Example Embodiment

The following is a brief introduction of aspects of various embodiments of the invention. This discussion is not intended to limit the scope of the invention, or the applicability of the embodiments, in any way.

One embodiment comprises a system and methodology for nuanced evaluation of earnings call transcripts, hinging on the exploration of historical information, such as analyst conduct and sentiment embedded in their queries, such as may be captured in an earnings call transcript and/or other document(s). Employing computational linguistics and ML (machine learning) algorithms, this system and method may facilitate automatic dissection of earnings call transcripts, and/or other documents, to discover behavior patterns of analysts, and gauging the sentiment indices of the questions proposed during these calls. In an embodiment, the system may spontaneously form questions, inspired by analyst behavior, bolstering the preparation of pre-structured queries prior to the earnings call.

An embodiment of the system has been built to decode and scrutinize analysts conduct during the earnings calls, and to fabricate a model illustrating their proclivities and preferences. This model acts as a substrate for the spontaneous generation of questions mirroring specific patterns and customary lines of inquiry based on historical scrutiny, thereby enabling corporations to better brace themselves for earnings calls and furnish more bespoke responses.

In addition, the system extends its analytical abilities to determine the sentiment of queries posed during earnings calls and calculates a cumulative sentiment index for each analyst. This sentiment index acts as a proxy for the market sentiment towards a corporation, and to pinpoint arenas that may necessitate added illumination or elucidation during earnings calls. By grasping the sentiment of the market, corporations can recalibrate their communications to depict a more precise and favorable fiscal status or, more generally, to communicate particular information in a particular way.

Incorporating a generative question feature, the system according to an embodiment can also spontaneously formulate questions, hinged on the behavior of certain analysts. Using the behavior model of the analysts, it frames questions aligning with their preferences, hence facilitating corporations to prime themselves with pre-structured responses to frequently posed queries prior to the earnings call. This feature also proves instrumental in spotlighting potential areas of concern requiring added explanation or illumination.

An embodiment exploits an analytical approach integrated into the process of earnings call transcripts. This approach is founded on the modeling of analyst conduct and the patterns in their questioning and harnesses an array of machine learning strategies to discern these patterns. To be more specific, the approach calculates the sentiment of queries posed during the calls by adopting a holistic method combining clustering algorithms, topic modeling, and deep learning algorithms.

Clustering algorithms have been utilized to categorize analysts based on their conduct during earnings calls, forming the basis to develop a conduct model for each analyst group. This model acts as a springboard to generate questions aligning with their preferences, therefore enabling corporations to better gear up for earnings calls and provide more bespoke responses. Topic modeling technique comes into play to identify recurrent themes discussed during earnings calls. This aids corporations in discerning the themes and topics intriguing to analysts, and to identify potential areas of concern that may necessitate further illumination or clarification during earnings calls.

Deep learning algorithms are employed to examine the sentiment of queries posed during earnings calls. These algorithms enable the calculation of a cumulative sentiment index for each analyst, serving as a tool to understand the market sentiment towards a corporation. This enables corporations to recalibrate their communications to deliver a more precise and favorable portrayal of their financial status. By amalgamating these diverse machine learning strategies, the disclosed invention delivers an exhaustive analysis of earnings call transcripts, empowering corporations to make informed decisions hinged on analysts' behavior and the market sentiment towards their corporation.

### B. Overview of Aspects of an Example Embodiment

An example embodiment comprises a system and method to effectively analyze earnings call transcripts, with a particular emphasis on examining analyst behaviors and sentiments within their queries. In the corporate world, earnings calls are critical communication events during which companies present their financial achievements for a given period, typically quarterly, to analysts, investors, and the public. These calls often entail a prepared statement followed by a Q&A session, where analysts can ask questions to better understand the company's financial health and prospects. These calls, and in particular, the analyst questions and behaviors during these calls, can greatly impact the market perception and sentiment towards the company. Thus, an ability to analyze and predict these behaviors and sentiments can provide strategic benefits to the company.

Thus, an embodiment comprises an approach to decode and analyze these critical events. It employs natural language processing (NLP) and machine learning techniques to decipher and examine earnings call transcripts automatically. The system identifies behavioral patterns of analysts and calculates sentiment scores of their questions, providing valuable insights into analyst perspectives and the market sentiment.

One aspect of an embodiment is the development of a model based on the behavior of analysts during earnings calls. This model, informed by machine learning algorithms, captures analyst tendencies and preferences, enabling the system to generate real-time questions that reflect specific patterns and common lines of questioning. This feature offers an invaluable tool for companies to prepare better for earnings calls and deliver more targeted and relevant responses.

In an embodiment, the system goes further to provide sentiment analysis of questions asked during these calls. It calculates an overall sentiment score for each analyst, offering insights into the market sentiment towards the company. This analysis can highlight areas needing further explanation during earnings calls and helps companies adjust their messaging for a more accurate and positive portrayal of their financial position.

Furthermore, the system according to one embodiment incorporates a generative question feature that can generate questions based on the conduct of certain analysts in real time. This feature, utilizing the analyst behavior model, can help companies prepare predefined answers to frequently asked questions and identify potential areas of concern needing further clarification.

An embodiment may leverage several machine learning techniques, such as clustering algorithms, topic modeling, and deep learning models. Clustering algorithms help categorize analysts based on their behavior, facilitating the development of behavior models for each group. Topic modeling identifies recurrent themes during the calls, helping companies understand the areas of interest for analysts. Deep learning models are used to analyze the sentiment of questions, enabling a comprehensive sentiment analysis for each analyst.

An embodiment comprises a method for enhancing the analysis and understanding of earnings call transcripts. By automating the analysis process, predicting analyst behavior, and interpreting market sentiment, this system could be instrumental in preparing companies for earnings calls and strategically managing their communication, thus enhancing their financial presentation and investor relations. As such, the potential industry implications of this patent are substantial, offering a significant contribution to the domain of financial communication and market sentiment analysis.

Following is a list of example features and advantages that may, but are not required to, be provided by an embodiment of the invention—these examples, which are not intended to limit the scope of the invention in any way—are focused on the value of early access to draft sentiment for better preparation before the actual quarterly earnings call:
Enhanced investment decision support
Analysts behavioral analysis
Improved market prediction capabilities
Strategic edge in the market
Operational efficiency
Flexible and adaptable solutions
Prompt insights and proactive decision-making
Fostering market confidence and openness

### C. Detailed Discussion of an Example Embodiment

### C.1 Introduction

An example embodiment may be particularly useful in the context of investor relations, facilitating preliminary analysis that may be used to develop an AI (artificial intelligence) co-pilot. An embodiment may enable this AI co-pilot to construct deep learning models serving various purposes, such as, but not limited to:
Transcript summarization—the AI co-pilot, employing NLP and machine learning techniques, can distill comprehensive earnings call transcripts into concise summaries. This swift information consumption is an asset for time-pressed stakeholders;
Report generation—the AI co-pilot autonomously creates insightful reports drawing on key elements from earnings calls like analyst behaviors and sentiment scores, thus aiding informed decision-making; and
Creation of automated dashboards—the AI co-pilot can develop dynamic dashboards with real-time metrics drawn from earnings call analyses, providing stakeholders with a quick, comprehensive view of key outcomes.

Further, an embodiment may aid the creation of deep learning models concerning earnings call analysis. By understanding analyst behavior and sentiment scores, an embodiment may refine the predictive capabilities of these model, and enhance the accuracy of insights generated. This capacity, along with its ability to generate questions, ensures these models are robust and applicable in real-world scenarios. An embodiment, implemented in connection with an AI co-pilot, may usefully affect investor relations, providing preliminary analysis to creating advanced models enriching the earnings call process.

### C.2 Possible Strategic Significance of an Embodiment

The possible strategic value of an embodiment may lie in its potential to significantly affect the preparation and analysis of earnings calls in the business sector. An embodiment may enhance the investment decision support system by granting early access to the sentiment analysis of earnings call drafts. This empowers investors and financial analysts with accurate insights, enabling them to make well-informed investment decisions, risk assessments, and portfolio management strategies.

Additionally, the improved market prediction capabilities afforded by the analytics implemented by an embodiment may lead to better forecasting. A comprehensive understanding of market sentiment equips businesses and investors to anticipate market trends, driving strategic decision-making.

Furthermore, an embodiment that implements a combination of advanced analysis techniques, adaptability methods, and early access to draft sentiment analysis may put financial institutions, hedge funds, and other market participants at an advantage over competitors who rely on conventional methods. Such early, accurate, insights into earnings calls and market sentiment may be leveraged to outperform competition.

Finally the capability of a system according to one embodiment to adjust to domain-specific rules and integrate with external data sources makes this embodiment a versatile and adaptable solution. This flexibility may ensure optimal performance and applicability, allowing businesses to stay ahead of the curve.

At present, there is no known approach to obtain sentiment scores and/or other sentiment information before a call without compromising the data with third party vendors. Consequently, a team must spend significant time to perform manual sentiment highlighting on earnings drafts, so that they can adjust wording to increase awareness of the impact of the earnings call. Further, a team cannot control the numbers but can control how they are discussed to mitigate the risk in stock price before or after earnings call.

### C.3 Example Method According to One Embodiment

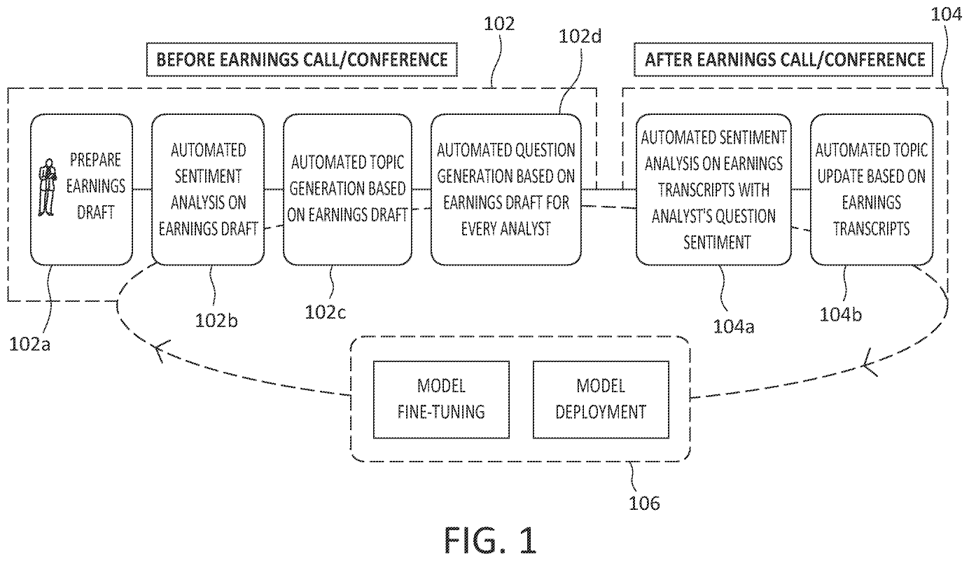

With reference now to FIG. 1, there is disclosed an overview of an example method 100 according to one embodiment of the invention. As shown, the example method 100 may be considered as having two phases, namely, a ‘Before’ phase 102 (“Before Earnings Call/Conference”) and an ‘After’ phase 104 (“After Earnings Call/Conference”). As also shown in FIG. 1, a model fine tuning and deployment process 106 may be ongoing, possibly continuously, during both the phases 102 and 104.

The ‘Before’ phase 102 may comprise, for example: preparation of an earnings draft 102a; performing an automated sentiment analysis 102b on the earnings draft; performing automated topic generation 102c based on the earnings draft; and performing automated question generation 102d, based on the earnings draft, for analysis. In an embodiment, this may conclude the ‘Before’ phase 102.

The ‘After’ phase 104 may comprise, for example: performing an automated sentiment analysis 104a on earnings call transcripts with analyst question sentiment; and, performing an automated topic update 104b, for another earnings call, based on the earnings call transcripts.

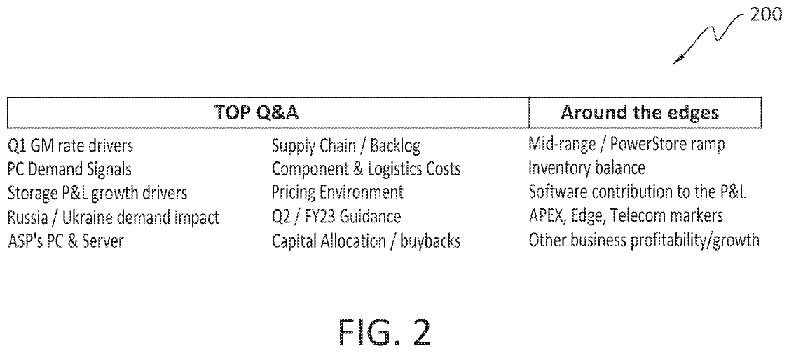

In general, an earnings call may involve the discussion of a wide variety of topics. With reference to FIG. 2, there is disclosed an example listing 200 of possible/expected topics as might be addressed during an earnings call. In the example of FIG. 2, the topics are broken into a first group of topics that is expected to be a priority in the call, and a second group of related but possibly lower priority topics.

### C.4 Sentiment Considerations

In an embodiment, the deep learning models are used to analyze the sentiment of questions asked during earnings calls. These models can calculate an overall sentiment score for each analyst, which can be used to understand the sentiment of the market towards a company. This allows companies to adjust their messaging to provide a more accurate and positive portrayal of their financial position. By combining these various machine learning techniques, the proposed invention provides a comprehensive analysis of earnings call transcripts, enabling companies to make informed decisions based on the behavior of analysts and the sentiment of the market towards their company.

Below, an approach is disclosed for obtaining a measure of sentiment for an analyst.

$${sentiment}_{score} = \frac{\begin{matrix}( {Count}_{PositiveSentences} * {Mean}_{PositiveSentimentScore} ) - \\ ( {count}_{NegativeSentences} * {Mean}_{NegativeSentimentScore} )\end{matrix}}{{Count}_{N} * {Mean}_{M}}$$

$$N = Total number of sentences$$

$$M = Overall Mean score$$

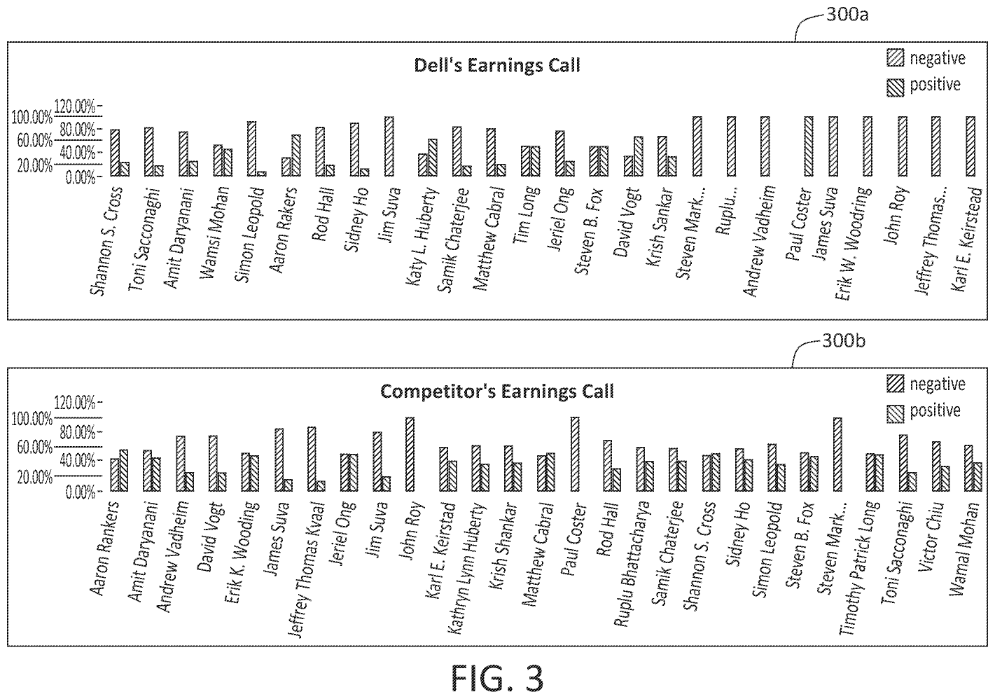

Turning next to FIG. 3, graphs 300a and 300b are presented that disclose, for each analyst on a call, and/or expected to be on a call, ratios of the types of questions asked, and/or expected to be asked by each analyst. This information is presented for a hypothetical Dell earnings call, and a hypothetical competitor call. The types of questions are classified as either negative or positive. For example, a question critical of the company may be classified as negative, while a question simply seeking further information may be classified as positive. The negativity or positivity of a particular question may be a reflection of the sentiment of the analyst associated with the question. As shown, some analysts are highly negative in their questions, while other analysts take a more balanced approach, and still other analysts are largely positive in their questions. In an embodiment, and with continued reference to the hypothetical examples of FIG. 3, the creation and use of a model to learn questions asked by analysts not only from Dell but also for competitive set of companies will help the model to understand the pattern and type of question based on company financial health for the earnings report to generate more accurate questions for that quarter earnings call conference beforehand.

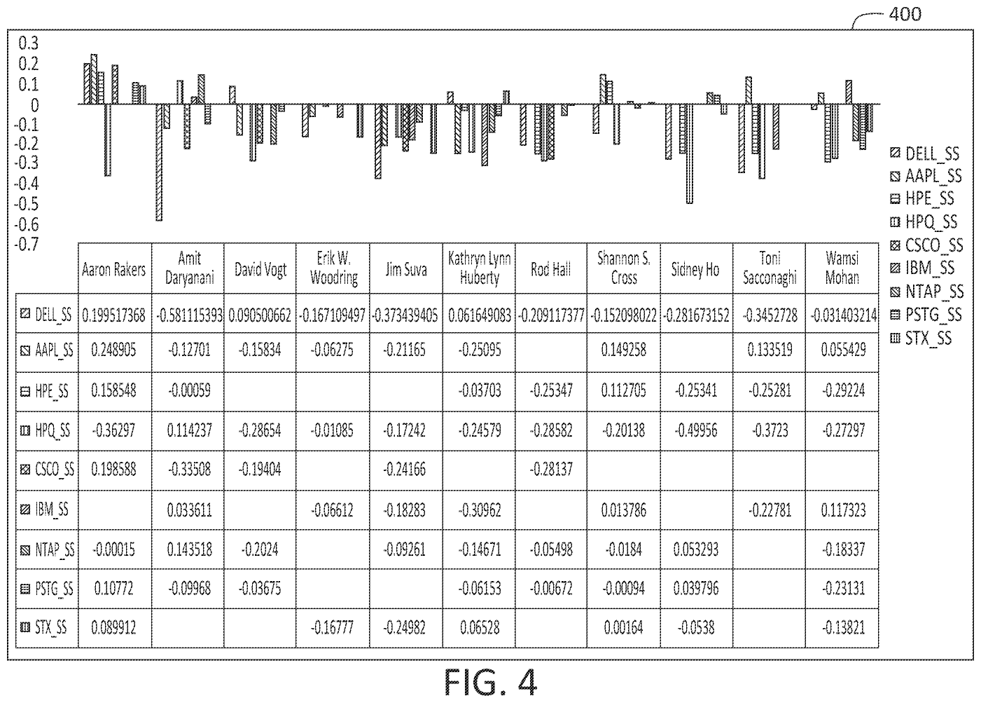

Turning next to FIG. 4, a chart 400 is disclosed that reveals, for various analyst questions, a sentiment comparison for a competitive set of companies. In the example of FIG. 4, analyst behaviors “Aggressive,” “Steadiness,” and “Influence” have been derived based on weighted sentiment score of questions asked by analysts in different organizations where the analysts profile matched and the mean of analyst ratings. “Steadiness” behavior is where analysts try to be precise and balanced while asking questions, “Aggressive” is where analysts inclined more towards negative questions and may have a blunt and have demanding approach, while “Influencer” analysts keep the questions light and positive. These definitions may be varied, or supplemented/replaced with other definitions, depending upon the application.

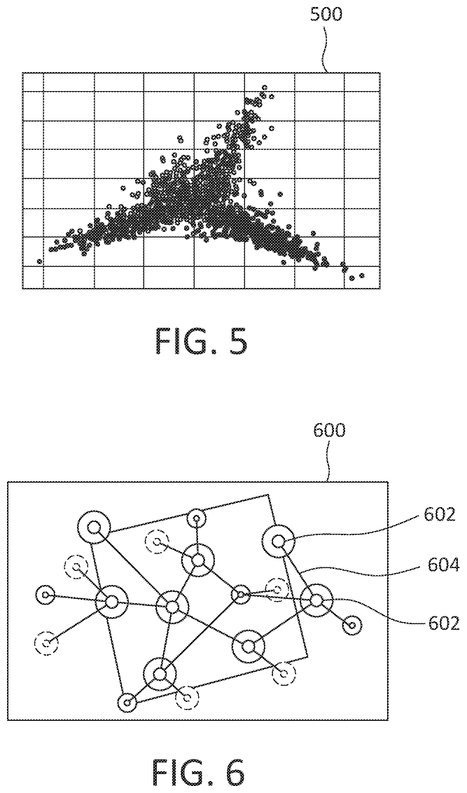

With reference now to FIG. 5, analysts may be grouped according to their respective ratings and sentiment score. This is illustrated by the graph 500 which comprises a behavioral cluster of analysts.

### C.5 Detailed Discussion of Aspects of an Example Embodiment

One example embodiment may comprise two components, namely, a knowledge graph, and a language model. Example implementations of a knowledge graph, and a language model are discussed hereafter.

### C.5.1 Knowledge Graph

With reference now to FIG. 6, an example knowledge graph 600 is disclosed. This particular example is a knowledge graph based on earnings call transcripts. In general, a knowledge graph, such as the example knowledge graph 600, comprises a visual representation that captures, and models, the relationship between various entities. It is a network of interconnected nodes, where each node 602 represents a particular entity or concepts, and each edge 604 or relationship between nodes represents a connection or association between those entities.

According to the size of the language model, discussed below, PLMs (pre-trained language models) are set to the maximum length of the input differently. For example, a small-sized model, base-sized model, and large-sized model, may set 256 tokens, 512 tokens, and 1024 tokens, respectively. To process a large document in PLMs, an embodiment may chunk the document according to language models size. However, the chunking process may miss important information included in the input texts. Consequently, a PLM may fail to generate the proper responses. To address this problem, an embodiment may leverage knowledge graphs, as exemplified in FIG. 6, that are able to sum up the document(s).

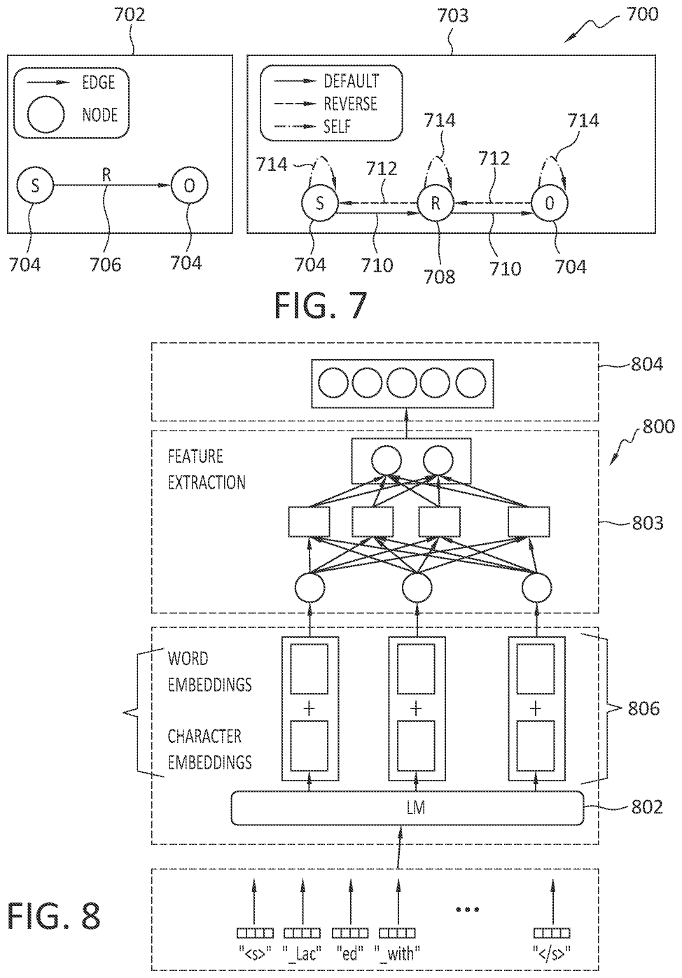

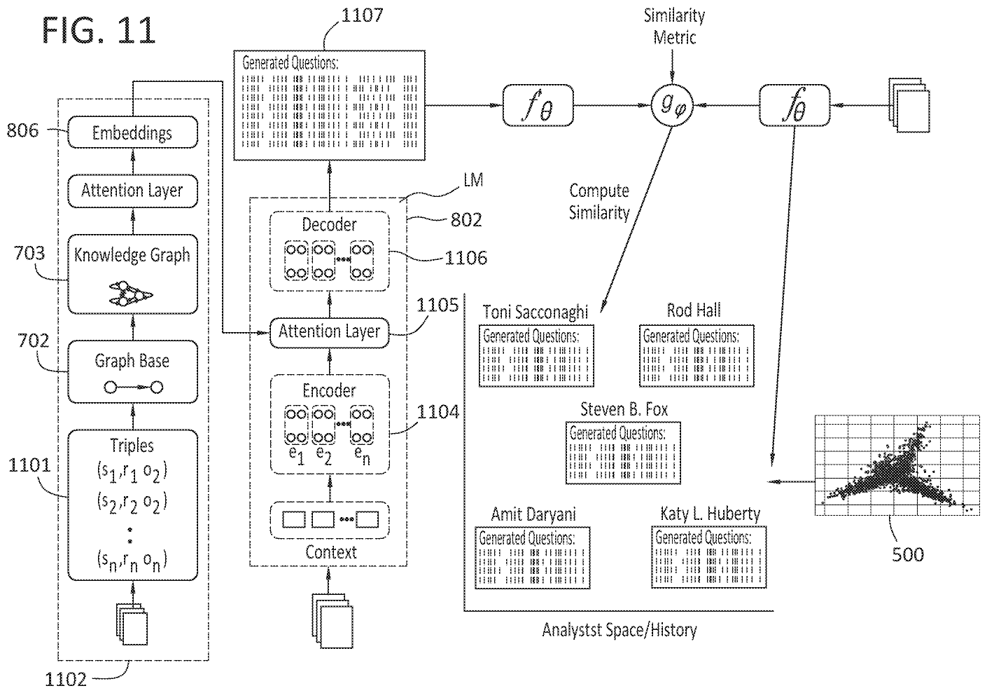

In more detail, and with reference now to the example procedure 700 of FIG. 7, a language model according to one embodiment may dynamically construct a knowledge graph, such as the knowledge graph 600 for example, from relevant document(s) and generate more informative and natural responses based on the knowledge graphs. In an embodiment, a first step in constructing a knowledge graph is extracting knowledge triples 1101 (subject, relation, object) (see FIG. 11) from the relevant document(s) 1102, to build a knowledge base. To use the triples as input, an embodiment may integrate the triples into basic graphs, and convert the basic graphs 702 into knowledge graphs 704. In the phase of integrating the triples, an embodiment may create nodes 704 based on the “subject” and “object” of the triple, and an edge 706 based on the “relation” of the triple. An embodiment may then connect the two nodes 704 via the edge 706. In the graph conversion phase, an embodiment may convert the edge 706 into a node 708 and connect the three nodes 704, 708, and 704, using new edges as follows: “default” 710, “reverse” 712, and “self” 714. “Default” is an edge that points in the existing direction, “Reverse” is an edge that points in the reverse direction of the edge “default,” and “Self” is an edge that points to itself.

We propose using knowledge graph to keep the conversational question-answering information by each analyst from transcripts intact, so while training LLM, it should not miss-out the information and pattern. To process earnings transcripts Q&A in PLLMs, the transcript may need to be chunked according to the model size, but there is also a need to keep information as questions asked by analyst can be relatable in next section question. To avoid this problem, a knowledge graph according to one embodiment may help to keep the track of questions pattern asked during the earnings call and that information can be fed to an embodiment of a PLLM to make it aware of the pattern and contextual information.

### C.5.2 Language Model

After generation of a knowledge graph, an embodiment may next choose a PLM (pre-trained language model) and fine-tune it. An LM according to one embodiment comprises an auto-regressive language model, this blends modeling techniques from autoencoder models into autoregressive models. This embodiment of the LM employs the permutational language modeling technique. To cover both forward and backward directions, the LM may evaluate all potential permutations. FIG. 8 discloses an example architecture 800 that includes an LM 802 according to one embodiment.

During training, the LM 802 uses a permutation operation to allow context to include tokens from both the left and right sides, capturing the bidirectional context. The LM 802 maintains the original sequence order, employs positional encodings, and employs a specific attention mask in transformers to achieve the factorization order permutation.

According to an embodiment, the LM 802 predicts the probability of observed text data. To train the LM 802, it may be helpful to have a large textual corpus available and in the process of learning robust features of the language it is modeling. The above pre-trained LM 802 may be then adapted to different downstream tasks by introducing additional parameters and fine-tuning them using task-specific objective functions. There are at least two ways to use the LM 802:
1. Supervised Learning: In a traditional supervised learning system for LM, an input x, usually text, may be used to predict an output y based on a model P (y|x; θ). Here, y could be a label, text, etc. To learn the parameters θ of this model, an embodiment may use a dataset containing pairs of inputs and outputs and train a model to predict this conditional probability.
2. Prompting: The main issue with supervised learning is that to train a model P (y|x; θ), it is necessary to have supervised data for the task, which for many tasks cannot be found in large amounts. In prompt-based learning methods instead learning an LM that models the probability P (x; θ) of text x itself and using this probability to predict y which reduce the need for large, supervised datasets.

An embodiment implements the promoting based LM 802 where in solution the “pre-train, fine-tune” procedure is replaced by “pre-train, prompt, and predict.” In this approach, instead of adapting pre-trained LMs to downstream tasks via objective engineering, downstream tasks are reformulated to look more like those solved during the original LM 802 training with the help of a textual prompt. A prompting function fₚᵣₒₘₚₜ(⋅) is applied to modify the input text x into a prompt x′=fₚᵣₒₘₚₜ(x). To apply a prompt template, which is a textual string: an input [X] for x and an output [Z] for an intermediate generated text z that will later be mapped into y.

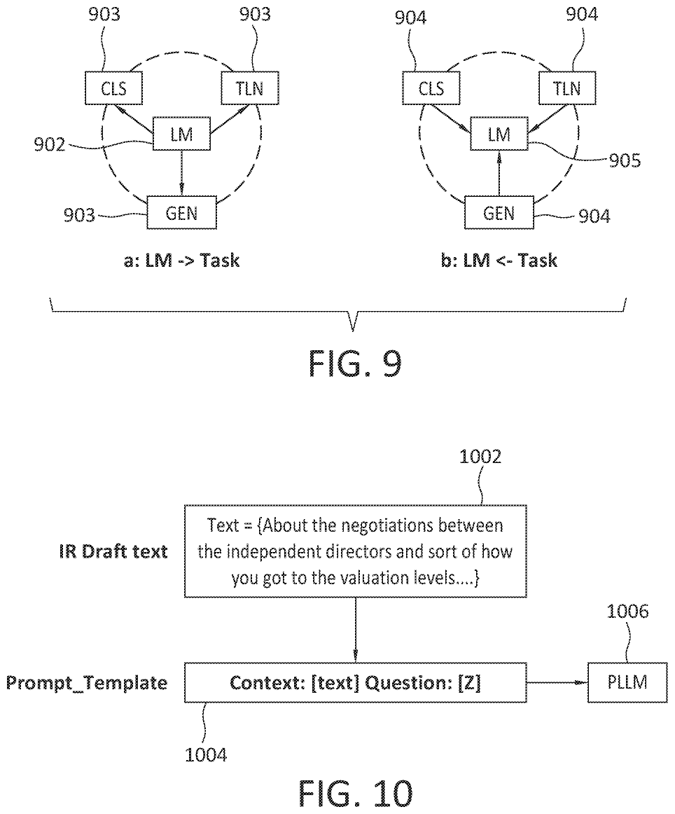

Turning next to FIG. 9, an approach is disclosed for LM task relation. In particular, on the left side of FIG. 9, LM→Task represents adapting LM 902 to downstream tasks 903 for one or more objectives such as masked language modeling and then next sentence prediction, and on the right side of FIG. 9, Task→LM denotes adapting downstream 905 tasks to LM 905.

By selecting the appropriate prompts, an embodiment may manipulate the model, that is, the LM, behavior so that the pre-trained LM itself can be used to predict the desired output, sometimes even without any additional task-specific training. The advantage of this method is that, by giving correct prompts, a single LM trained in an entirely unsupervised fashion can be used to solve a great number of tasks.

There are number of prompting methods such as pre-trained, multi-prompt learning, and prompt-based training, for example. An embodiment may employ a prompt-based training strategy for question generation from earnings report. In prompt-based training, a tuning-free prompting strategy is selected. Tuning-free prompting directly generates the text without changing the parameters of the pre-trained LMs based only on a prompt. Question generation is a task that involve generating questions, usually conditioned on some contextual information. Prompting methods can be easily applied to this task by using prefix prompts together with autoregressive pre-trained LMs.

To illustrate, an example prompt that may be used for question generation in one embodiment is disclosed in FIG. 10, which discloses an approach for prompt learning for question generation. As shown there, input text, which may be specified by way of a text template 1002, may be provided to a prompt template 1004 which may, based on the input text, generate a prompt or ‘Question.’ The prompt may then be provided as an input to an LLM, such as a PLLM 1006 (pre-trained large language model) for example.

Thus, an embodiment has used a PLLM to fine-tune the proposed model using knowledge graphs with a question-answering history in earnings transcripts. In the encoder layer 1104 (see FIG. 11) of LM 802 feed contexts X={x1, x2, . . . , xn}. An embodiment may then use the encoder, below, to convert the contexts into hidden states H={h₁, h₂, . . . , hn}:

$$H = Encoder ( X ) .$$

The knowledge graphs constructed as described in the knowledge graph discussion above are encoded using a graph attention network (GAT) to leverage the relevant document(s).

$${g}_{i}^{′ \to } = σ ( \frac{1}{K} {\sum }_{k = 1}^{1} {\sum }_{j ϵ {N}_{i}} {α}_{ij}^{k} {W}^{k} {g}_{j}^{\to } )$$

$$G = [ {g}_{1}^{′ \to } , {g}_{2}^{′ \to } , {g}_{3}^{′ \to } , ... , {g}_{N}^{′ \to } ]$$

where g′ᵢ^{→} denotes the final output representation of the i-th node g′ᵢ^{→}∈ [symbol] , where dₖ denotes the LM embedding size, K is the number of heads, W^{k} is the corresponding input weight matrix, Ni are neighbor nodes of the i^{th} node in the graph, and αᵢⱼ^{k} is normalized attention coefficients.

In the attention layer 1105, matrices Attention (H, G, G) to the hidden states H use a residual connection to obtain matrix F, which reflects background knowledge.

$$Attention ( H , G , G ) = softmax ( \frac{{HG}^{T}}{\sqrt{{d}_{k}}} ) G$$

$$F = Attention ( H , G , G ) + H$$

where Attention (H, G, G) is calculated using a scaled dot-product attention mechanism, and dₖ is a normalization factor. In the decoder layer 1106, matrix F is used as the input for an LM decoder to generate the yᵢ that the desired output, in this case, the questions 1107 (see FIG. 11) for the earnings call.

Once questions are generated for the earnings draft, an embodiment may, using the architecture 800 of FIG. 8, extract 803 (see FIG. 8) the features 804 (see FIG. 8) of text, that is, embeddings 806 (see FIG. 8) generated from the LM 802 (see FIG. 8) to compute the cosine similarity, or other similarity metric (see FIG. 11), based on learned history of questions embeddings asked by each analyst and assign the generated question to cluster plane of analysts it closely matches to. An embodiment has then created the cluster plane of analysts using history of each analyst, that is, the analyst behavior, and question sentiment, and the features of type of questions.

Attention is briefly directed to FIG. 11, in which various elements of the other Figures, discussed earlier herein, are collected together to indicate the relationships between/among those elements. The numbering of such elements in the earlier Figures is retained, where possible, in FIG. 11.

### D. Further Discussion

As will be apparent from this disclosure, one or more example embodiments may possess various useful features and aspects, although no embodiment is required to possess any of such features and aspects. The following features and aspects are provided by way of example.

For example, an embodiment may use clustering techniques to group analysts based on their behavior during earnings calls, enabling better understanding of analyst tendencies and preferences, and enabling generation of targeted responses to questions to permit companies to better prepare for earnings calls.

Another example relates to historical questions sentiment analysis. In particular, an embodiment may utilize one or more models to analyze the sentiment of historical questions asked during earnings calls, allowing companies to identify potential areas of concern and adjust messaging and presentation of information accordingly. The sentiment analysis on historical questions can also be used to prepare and adjust messaging and presentation of information prior to earnings calls to mitigate the risk of negative impact on stock prices on the day of earning call.

A final example concerns generative question capability. Specifically, an embodiment may generate questions on-the-fly based on the behavior of analysts. This capability involves the development of a generative model that utilizes the behavior model of analysts to generate questions that are tailored to their preferences. This can help in identifying potential areas of concern and enabling companies to prepare pre-defined answers for frequently asked questions before the earnings call.

As will also be apparent from this disclosure, an embodiment may comprise one or more improvements relative to the art. For example, while there is no known architecture for question generation in the finance domain, an embodiment may comprise business specific question generator which involves earning call transcripts/reports. As another example, while language models exist that are trained on financial data, these models do not perform well in the generative modeling domain. On the other hand, an embodiment comprises a generative model that is specifically trained for use in the finance domain. Further, although generative models used for question-answering and for question generation exist, these existing models are unsophisticated and are generally limited to generation of only primitive question forms. As a final example, there are no known approaches for generating questions based on analyst behavioral pattern, while an embodiment, on the other hand, can generate and suggest question asked by analysts for the current earnings.

### E. Illustrative Examples and Glossary

### E.1 Examples

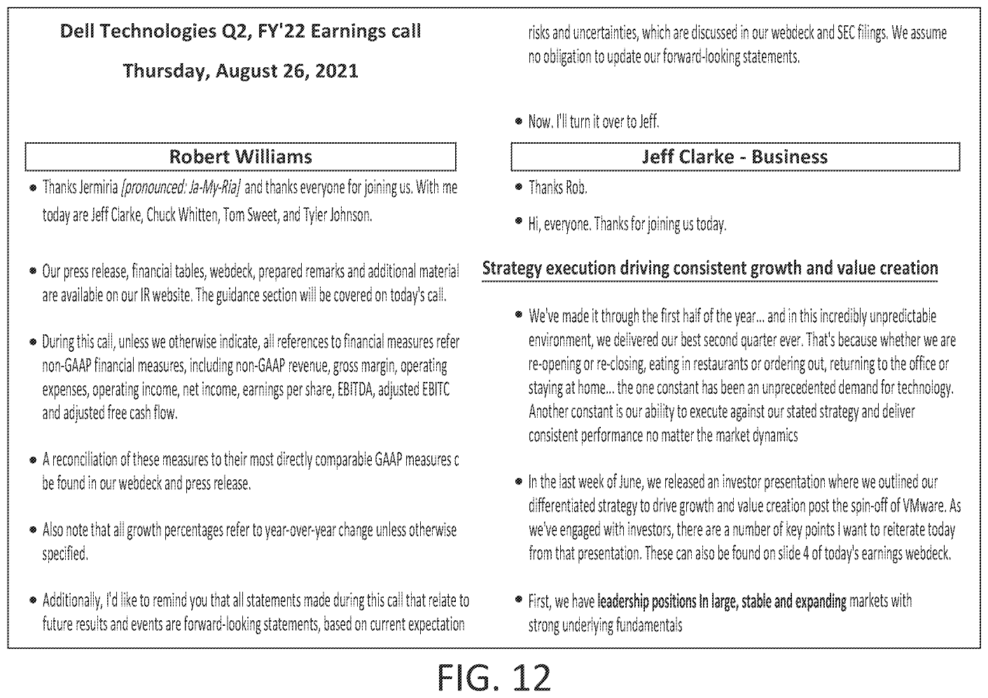

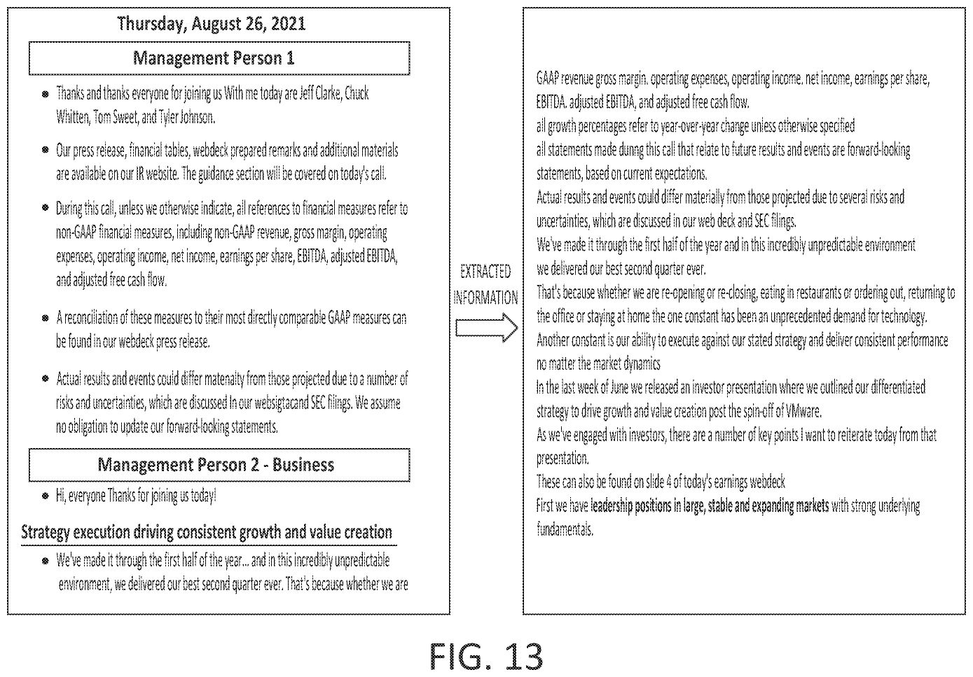

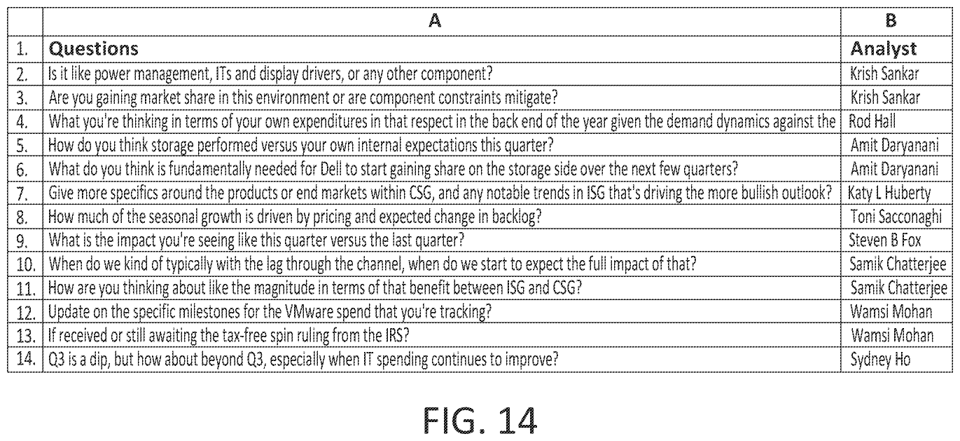

With attention now to FIGS. 12-14, some example applications of an embodiment are disclosed. FIG. 12 discloses an example earnings report, FIG. 13 discloses information extraction from an earnings report, and FIG. 14 discloses example questions generated based on analyst behavior. Thus, these Figures collectively comprise an example of sentiment analysis on a dell earning call transcript.

As shown, the example transcript comprises various sections-such as Event Type (every quarter), Date (date of event), Company (Organizer), Ticker, Company Participants, and other participants (analyst who would be most likely to be part or invest into company), and Discussion section wherein senior management discusses the financial results for the given reporting period and guidance on expected future performance. After the discussion portion is a Q&A portion wherein interested parties, such as analysts and investors, can ask questions of senior management. Analysts and investors closely follow earnings calls to extract signals that inform their investment advice and decisions.

With the methodology, according to one embodiment, upon the reception of the earning call transcript, the pipeline will extract the required information, such as the Discussion section and Q&A section, from the transcript. After extracting information, the pipeline will clean the data and remove all the unwanted words and will focus on financial related terms to get the sentiment as sentence level. Finally, one or more questions may be generated based on the analyst sentiment information.

### E.2 Glossary

Following is a list of terms appearing in this disclosure.

| Term | Definition |
|---|---|
| Knowledge Graph | Type of knowledge representation |
| | that captures and models |
| | the relationships between various |
| | entities and concepts in |
| | particular domain. It can store and |
| | organize information in a |
| | structured and semantically |
| | meaningful way, enabling more |
| | efficient and accurate processing |
| | and analysis of complex data. |
| LLM | Large language model that uses |
| | deep neural network with |
| | many parameters to model the |
| | relationship between words in |
| | natural language. They can be |
| | used for wide range of tasks, |
| | such as language translation, |
| | question-answering, sentiment |
| | analysis etc. |
| IR | Investor Relations |
| Q&A | Question and Answer |
| NLP | Natural Language Processing |

### F. Example Methods

It is noted with respect to the disclosed methods, including the example methods of FIGS. 1, 7, 8, 10, and 11, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments of the invention. These are presented only by way of example and are not intended to limit the scope of the invention in any way.
Embodiment 1. A method, comprising: preparing a document draft; performing an automated sentiment analysis on the document draft; performing an automated topic generation process based on the document draft and based on an outcome of the automated sentiment analysis; performing an automated question generation process based on the document draft and based on an outcome of the automated topic generation process, and the automated question generation process is performed for each of one or more consumers of the document draft; after consumption of the document draft by the consumers, performing another automated sentiment analysis process on the document draft using sentiments associated with input, concerning the document draft, provided by the consumers; and automatically updating a list of topics, generated by the automated topic generation process, based on contents of a transcript that includes the input provided by the consumers.
Embodiment 2. The method as recited in any preceding embodiment, wherein the document draft comprises an earnings draft containing financial information concerning a business entity.
Embodiment 3. The method as recited in any preceding embodiment, wherein the consumers comprise financial analysts and media members.
Embodiment 4. The method as recited in any preceding embodiment, wherein automatically updating a list of topics comprises updating the list of topics to include one or more topics generated based on the another sentiment analysis.
Embodiment 5. The method as recited in any preceding embodiment, wherein the list of topics comprises one or more questions and/or comments expected to be posed by one or more of the consumers.
Embodiment 6. The method as recited in any preceding embodiment, wherein performing the automated sentiment analysis on the document draft comprises assigning a respective sentiment to each topic in the document draft.
Embodiment 7. The method as recited in any preceding embodiment, wherein the input provided by the consumers comprises spoken and/or written words.
Embodiment 8. The method as recited in any preceding embodiment, wherein the sentiments comprise sentiments of the consumers as expressed in and/or by the input.
Embodiment 9. The method as recited in any preceding embodiment, wherein the consumers whose sentiments are associated with the input are selected using a behavioral model that uses a clustering algorithm to select the consumers.
Embodiment 10. The method as recited in any preceding embodiment, wherein the list of topics comprises one or more questions and/or comments that correspond to the sentiments.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

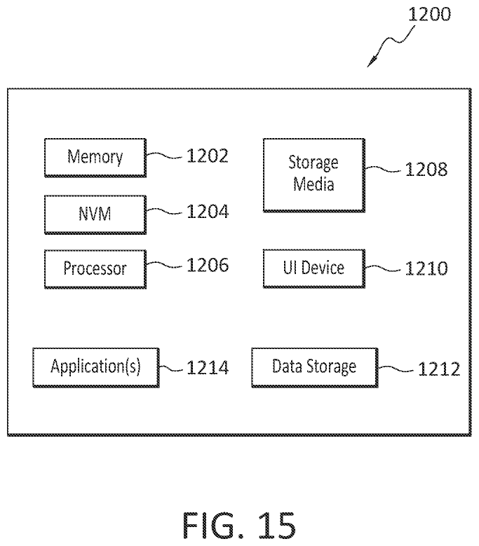

With reference briefly now to FIG. 15, any one or more of the entities disclosed, or implied, by FIGS. 1-14, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 15.

In the example of FIG. 15, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
preparing a document draft;
performing an automated sentiment analysis on the document draft;
performing an automated topic generation process based on the document draft and based on an outcome of the automated sentiment analysis;
performing an automated question generation process based on the document draft and based on an outcome of the automated topic generation process, and the automated question generation process is performed for each of one or more consumers of the document draft;
after consumption of the document draft by the consumers, performing another automated sentiment analysis process on the document draft using sentiments associated with input, concerning the document draft, provided by the consumers; and
automatically updating a list of topics, generated by the automated topic generation process, based on contents of a transcript that includes the input provided by the consumers.

2. The method as recited in claim 1, wherein the document draft comprises an earnings draft containing financial information concerning a business entity.

3. The method as recited in claim 1, wherein the consumers comprise financial analysts and media members.

4. The method as recited in claim 1, wherein automatically updating a list of topics comprises updating the list of topics to include one or more topics generated based on the another sentiment analysis.

5. The method as recited in claim 1, wherein the list of topics comprises one or more questions and/or comments expected to be posed by one or more of the consumers.

6. The method as recited in claim 1, wherein performing the automated sentiment analysis on the document draft comprises assigning a respective sentiment to each topic in the document draft.

7. The method as recited in claim 1, wherein the input provided by the consumers comprises spoken and/or written words.

8. The method as recited in claim 1, wherein the sentiments comprise sentiments of the consumers as expressed in and/or by the input.

9. The method as recited in claim 1, wherein the consumers whose sentiments are associated with the input are selected using a behavioral model that uses a clustering algorithm to select the consumers.

10. The method as recited in claim 1, wherein the list of topics comprises one or more questions and/or comments that correspond to the sentiments.

11. A non-transitory storage medium having stored therein instructions that are executable by one or more hardware processors to perform operations comprising:
preparing a document draft;
performing an automated sentiment analysis on the document draft;
performing an automated topic generation process based on the document draft and based on an outcome of the automated sentiment analysis;
performing an automated question generation process based on the document draft and based on an outcome of the automated topic generation process, and the automated question generation process is performed for each of one or more consumers of the document draft;
after consumption of the document draft by the consumers, performing another automated sentiment analysis process on the document draft using sentiments associated with input, concerning the document draft, provided by the consumers; and
automatically updating a list of topics, generated by the automated topic generation process, based on contents of a transcript that includes the input provided by the consumers.

12. The non-transitory storage medium as recited in claim 11, wherein the document draft comprises an earnings draft containing financial information concerning a business entity.

13. The non-transitory storage medium as recited in claim 11, wherein the consumers comprise financial analysts and media members.

14. The non-transitory storage medium as recited in claim 11, wherein automatically updating a list of topics comprises updating the list of topics to include one or more topics generated based on the another sentiment analysis.

15. The non-transitory storage medium as recited in claim 11, wherein the list of topics comprises one or more questions and/or comments expected to be posed by one or more of the consumers.

16. The non-transitory storage medium as recited in claim 11, wherein performing the automated sentiment analysis on the document draft comprises assigning a respective sentiment to each topic in the document draft.

17. The non-transitory storage medium as recited in claim 11, wherein the input provided by the consumers comprises spoken and/or written words.

18. The non-transitory storage medium as recited in claim 11, wherein the sentiments comprise sentiments of the consumers as expressed in and/or by the input.

19. The non-transitory storage medium as recited in claim 11, wherein the consumers whose sentiments are associated with the input are selected using a behavioral model that uses a clustering algorithm to select the consumers.

20. The non-transitory storage medium as recited in claim 11, wherein the list of topics comprises one or more questions and/or comments that correspond to the sentiments.
